(19) United States
(12) Patent Application Publication
(10) Pub. No.: US 2014/0280865 A1
(43) Pub. Date: Sep. 18, 2014

(54) NETWORK-PROXIMITY-BASED EVENTING

(71) Applicant: CISCO TECHNOLOGY, INC., San Jose, CA (US)

(72) Inventors: Daniel R. Albertson, Issaquah, WA (US); Thomas E. Logan, Bothell, WA (US); Siddhartha Dattagupta, Irvine, CA (US); David Ben-Yaakov, San Ramon, CA (US)

(73) Assignee: CISCO TECHNOLOGY, INC., San Jose, CA (US)

(21) Appl. No.: 13/803,059

(22) Filed: Mar. 14, 2013

(51) Int. Cl. H04L 12/26

(52) U.S. Cl. CPC H04L 43/10
USPC 709/224

(57) ABSTRACT

In one embodiment, a network device detects a proximity state change of a mobile device in relation to the detecting network device, and compares the state change and mobile device to a set of configured policies. Based on one or more particular policies matching the state change and the mobile device, the network device may then perform one or more configured actions.

### TECHNICAL FIELD

The present disclosure relates generally to computer networks, and, more particularly, to managing events related to network proximity.

### BACKGROUND

Many locations, such as a user's home or office, often have a number of configurable features, such as lights that can be turned on/off, heat that can be increased or decreased, etc. Often, such configurable features are related to whether a user is currently within the location.

In addition, monitoring an event that is happening in or around a user's home (or other location) is often valuable to users that are outside of their home (or other location). In particular, users often want to monitor events occurring inside their home while they are away.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example networked device;

FIGS. 3A-3B illustrate an example of network-proximity-based eventing;

FIGS. 4A-4B illustrate another example of network-proximity-based eventing;

FIGS. 5A-5B illustrate another example of network-proximity-based eventing; and

FIG. 6 illustrates an example simplified procedure for network-proximity-based eventing in a communication network.

### DESCRIPTION OF EXAMPLE EMBODIMENTS

### Overview

According to one or more embodiments of the disclosure, a network device detects a proximity state change of a mobile device in relation to the detecting network device, and compares the state change and mobile device to a set of configured policies. Based on one or more particular policies matching the state change and the mobile device, the network device may then perform one or more configured actions.

### Description

A computer network is a geographically distributed collection of nodes interconnected by communication links and segments for transporting data (e.g., voice, video, and/or data) between end nodes, such as personal computers and workstations, portable computers (e.g., laptops, tablets, etc.), smartphones, or other devices, such as sensors, etc. Many types of networks are available, ranging from Local Area Networks (LANs) to Wide Area Networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, Synchronous Optical Networks (SONET), Synchronous Digital Hierarchy (SDH) links, etc.

FIG. 1 is a schematic block diagram of an example communication network 100 illustratively comprising various sites (e.g., site “A” and “site B”), such as where local networks or LANs (e.g., homes, schools, businesses, etc.) may be interconnected by a global network (e.g., the public Internet) or WAN 105 via a collection of networking devices. Illustratively, user devices 110 (e.g., 112 and 114) may interconnect at various times with a network device (e.g., locational router) 120, such as a home wireless router, a business wired router, etc. Additionally, various servers 130, such as notification servers, service provider servers, etc., may be interconnected with the global network 105 (and/or within respective local networks). Moreover, event actuators 140, such as energy controls, heat controls, alarm controls, etc., may also be present within the various sites.

Note that the links between the devices may generally be wired or wireless. Data packets (or frames) 150 may be exchanged among the devices of the computer network 100 over the links using predefined network communication protocols such as certain known wired protocols, wireless protocols, or other protocols where appropriate. In this context, a protocol consists of a set of rules defining how the nodes interact with each other. In general, the connections to/from and between the networks may comprise IPv4 and/or IPv6 (or one or more translations between the two), without being specifically distinguished herein. Those skilled in the art will understand that any number of nodes, devices, links, etc. may be used in the computer network, and that the view shown herein is for simplicity. Also, those skilled in the art will further understand that while the is network is shown using a certain device naming convention, the network 100 and the device names are merely an example illustration that is not meant to limit the disclosure.

FIG. 2 is a schematic block diagram of an example device 200 that may be used with one or more embodiments described herein, e.g., as any of the user devices 110, network devices 120, servers 130, actuators 140, etc. shown in FIG. 1 above. The device may comprise one or more network interfaces 210 (e.g., wired, wireless, power-line communication (PLC), etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise a communication process 244 (e.g., for various routing protocols, authorization and/or authentication, etc., as will be understood by those skilled in the art), and an illustrative “eventing” process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

As noted above, many locations have a number of configurable features, such as lights, heat, alarms, etc., where such configurable features are often related to whether a user is currently within the location. Further, monitoring an event that is happening in or around a user's home is often valuable to users that are outside of their home, such as to monitor events occurring inside their home while they are away.

The techniques herein provide an “eventing” and notification mechanism that proactively performs actions based on events and/or notifies users of events occurring within a given location (e.g., their home). In particular, as described herein locational routers (e.g., a home wireless router) may detect devices that are connected to it, and may perform any configured set of actions based on a change in the proximity status of the device (e.g., connecting and/or disconnecting). Said differently, when a user's mobile (e.g., wireless) device, such as a smartphone, mobile phone, tablet computer, laptop computer, music player, etc., connects or disconnects to a particular network (e.g., home or work network, etc.), different actions may be performed accordingly.

Specifically, according to one or more embodiments of the disclosure as described herein, a network device detects a proximity state change of a mobile device in relation to the detecting network device, and compares the state change and mobile device to a set of configured policies. Based on one or more particular policies matching the state change and the mobile device, the network device may then perform one or more configured actions.

Illustratively, the techniques described herein may be performed by hardware, software, and/or firmware, such as in accordance with the “eventing” process 248, which may contain computer executable instructions executed by the processor 220 to perform functions relating to the techniques described herein, e.g., within a user device 110, network device (e.g., router) 120, and/or (or in conjunction with) notification servers 130, event actuators 140, etc.

Operationally, detecting a proximity state change may be based on various proximity detection factors, such as whether the mobile device has connected to the network device or disconnected from the network device. For example, when a mobile device connects to a home wireless router, various credentials may be exchanged between the mobile device and the router, allowing the mobile device to communicate on the local network. In such an instance, it can be determined that the mobile device has connected to the network device. Conversely, if the mobile device leaves the proximity of the network device, such as physically being removed from a wireless range of the network device, then connectivity protocols as will be appreciated by those skilled in the art (e.g., beacons, probes, “liveness” monitoring, or explicit disconnection) will allow the network device to determine that the mobile device has disconnected. Other proximity detection techniques may be used, such as sensors, radio frequency signatures, etc., without necessarily establishing a “connection” between the mobile device and the network device.

Additionally, the configured actions may be preconfigured (e.g., by a manufacturer) or configured by an administrator of the network device (e.g., by the user). Example actions may be local to the network device (e.g., within site A) or remote to the network device (e.g., outside of site A, such as within global network 105, site B, etc.). Also, it should be noted that one or more actions may be configured, such as performing a local and a remote action in response to the same proximity state change.

As examples of local configured actions, an actuator (event actuator 140) may be configured to receive instructions from the network device to lock/unlock a door, arm/disarm and alarm or security system (e.g., turning it on when leaving, turning it off when returning home), turn lights on/off, turn on/off environmental controls, manage other energy profiles, etc. Alternative examples of local configured actions may comprise sending a notification to a locally connected user device, logging the state is change at the network device, etc.

FIGS. 3A-3B illustrate an example of network-proximity-based eventing, particularly with regard to local actions. For instance, as shown in FIG. 3A, assuming that a mobile device 112 enters the proximity of the network device 120 (e.g., a mobile phone connecting to the WiFi of a home networking router), then one or more actuation instructions may be sent to one or more respective event actuators, such as turning off a security system and/or turning on lights. Alternatively, as shown in FIG. 3B, when the network device 120 detects or otherwise determines that the mobile device 112 has left its proximity (e.g., has disconnected or otherwise gone silent), then one or more actuation instructions may also be sent to event actuators, such as arming the security system and shutting off the lights. Other configurable options are available according to the techniques herein, such as logging the proximity state changes, only disarming the alarm but not arming the alarm, etc., and those shown in this example are not meant to limit the scope of the present disclosure.

Additionally, as examples of remote configured actions, the proximity detecting network device may send a notification to a remotely connected user device and/or to a remote server, and may log the state change at a remote server (configured to receive instructions from the network device). In addition, in one or more embodiments, the communication between the network device 120 and the remote device may be based on a “push” or “pull” model, where the network device may either send notifications and/or instructions in an unsolicited manner in response to detected changes in proximity state (i.e., a push model), or may respond/reply to remote inquiries (from servers, user devices, etc.) regarding proximity state of any mobile device (are any devices present?) or any one or more specific mobile devices (i.e., a pull model).

FIGS. 4A-4B illustrate another example of network-proximity-based eventing, where notification is sent to a remote user regarding proximity of a mobile device to the network device 120. For instance, as shown in FIG. 4A, when a mobile device 112 (e.g., a configured particular mobile device, such as a child's cell phone) is within proximity of is the network device 120 (e.g., the child has returned home, and the cell phone has connected to the home WiFi), then the network device may send a notification (optionally via notification server 130 or otherwise) to the remote mobile device 114 (e.g., a parent's cell phone or email system). In the reverse, if the mobile device 112 leaves the proximity of the network device 120 (e.g., the child leaves the home), then a notification of the disconnection may also be sent to a remote mobile device 114, as shown in FIG. 4B.

In addition, FIGS. 5A-5B illustrate another example of network-proximity-based eventing. In particular, in this example, assume that an event actuator 140, such as an alarm system, is in communication with the network device 120 (e.g., a home router), and updates the network device with the current security status (e.g., armed, disarmed, detected alert/activity, etc.). Assume as shown in FIG. 5A that a mobile device 112 returns to site A (e.g., the home), and the network device 120 detects this proximity state change (e.g., the device connects to the home network). If the alarm system detects an alarm event, such as from a door opening, it may send a notification to a central alarm server 130 if the alarm is not disarmed within the given time limit. At the same time, however, through policy configuration, the network device 120 may also send a notification to the central alarm system 130 indicating that an authorized mobile device has entered the home. In this scenario, the alarm company may call the user on the mobile device 112 (or other home number) as shown in FIG. 5B to first determine whether the user is having difficulty with the alarm system, thus confirming the alarm rather than contacting police for what may be a false alarm. Any number of security policies such as this may be configured through policies and communication messages, and this example is merely one representative example of such possibilities.

Notably, though certain examples of proximity have been described above, other types of proximities may be correlated with a set of governing policies to create events that are consumed (e.g., performed, logged, managed) either by a computing entity, a user device, or another device in proximity. In particular, the following types of proximity may result in a proximity state change as described herein:

A) Single network proximity: When a device joins a particular network, such as a home LAN, the proximity may be defined as the direct connectivity of the device to the is network device which is capable of recognizing at least the state of the physical link between the device and itself. Some examples are as below:
1. A device that joins the wireless access point is directly associated to that wireless infrastructure node (e.g., joining the home WiFi, as described above).
2. A device that is physically connected to a switch that is in turn connected to a router.

B) Mesh network proximity: A network, such as a home LAN, meter network, sensor network, etc., can comprise a plurality of interconnected network nodes (e.g., called a “mesh” of interconnected network elements). If a device is connected to one of those nodes in the mesh, the device could be considered to be in the proximity of all the interconnected connected nodes. Note that policies could define how “deeply” (i.e., how far and/or how many hops between the device and the detecting network device) a device can be connected to the mesh before being considered out of the proximity, or where certain devices are defined to otherwise be considered out of the proximity (e.g., “islanding” the device within the mesh for security reasons).

C) Inter-device proximity: A device that is in proximity of another device which has a physically connected resource can consider that resource to be in proximity. For example, a personal computer that is connected to a wireless access point can have a storage device plugged into it (e.g., a universal serial bus or “USB” device). This in turn makes the storage device to be in proximity of the wireless access point.

D) Virtual network proximity: When multiple networks are connected through an entity (such as a cloud-based managed service), a device entering and joining one network, i.e., it is physically in proximity of that network, may be considered to be virtually in proximity of other connected networks. Examples could be as below:
1. A user owns multiple home networks (e.g., network 1 through N). The user also owns multiple mobile devices. If the user's device joins network-1 and is visible in another network (network 2 through N), then the device may be considered to be in virtual proximity of the remote networks 2 through N as well. These policies and eventing may generally be governed by a management entity (e.g., a cloud entity).
2. User-2 is a guest of User-1's network. User-2's device-1 is in physical proximity of User-2's own network. User-2's device-2 is in physical proximity of User-1's network, but connects virtually to device-1. Device-1 could now be seen in proximity of device-2. However, the device-1 in User-2's network might not be seen in proximity of User-1's network. Again, these are governed by policies and eventing that crosses the boundaries of physical and virtual networks.

FIG. 6 illustrates an example simplified procedure 600 for network-proximity-based eventing in a communication network in accordance with one or more embodiments described herein. The procedure 600 may start at step 605, and continues to step 610, where, as described in greater detail above, a network device 120 (e.g., a location router) detects a proximity state change of a mobile device 110 in relation to itself, such as whether the device is connecting or disconnecting to/from the network device. By comparing the state change and mobile device to a set of configured policies in step 615, the network device may then perform one or more configured actions in step 620 based on one or more particular policies matching the state change and the mobile device. For instance, as described in greater detail above, the actions may be local and/or remote, such as instructing an actuator to perform an operation, sending a notification, etc. The simplified procedure may then end in step 625, notably with the option to repeat at step 610 in response to further state changes of the mobile device or other mobile devices, accordingly.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for network-proximity-based eventing in a communication network. In particular, the techniques herein perform intelligent actions based on network presence.

While there have been shown and described illustrative embodiments that provide network-proximity-based eventing, it is to be understood that various other adaptations and modifications may be made within the spirit and scope of the embodiments herein.

For example, the embodiments have been shown and described herein with relation to current network technologies and devices, and current forms of detecting proximity. However, the embodiments in their broader sense are not as limited, and may, in fact, be used with other types of network and/or communication/proximity protocols. In addition, while certain types of events, actions, or notifications have been described, it is noted that such events and notifications are merely examples, and any suitable actions, events, and/or notifications may be performed and/or detected according to the techniques described herein.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
detecting a proximity state change of a mobile device in relation to a detecting network device;
comparing the state change and mobile device to a set of configured policies; and
performing one or more configured actions based on one or more particular policies matching the state change and the mobile device.

2. The method as in claim 1, wherein detecting the proximity state change comprises:
determining whether the mobile device has connected to the network device or disconnected from the network device.

3. The method as in claim 1, wherein the proximity state change is based on one of either mesh network connectivity to the network device or inter-device connectivity to the network device.

4. The method as in claim 1, wherein the proximity state change is based on virtual connectivity to the network device.

5. The method as in claim 1, wherein the one or more configured actions are local to the network device.

6. The method as in claim 5, wherein the local configured actions are selected from a group consisting of: instructing an actuator to lock/unlock a door; instructing an alarm system to arm/disarm; instructing lights to turn on/off; instructing environmental controls to turn on/off; sending a notification to a locally connected user device; and logging the state change at the network device.

7. The method as in claim 1, wherein the one or more configured actions are remote to the network device.

8. The method as in claim 7, wherein the remote configured actions are selected from a group consisting of: sending a notification to a remotely connected user device; sending a notification to a remote server; logging the state change at a remote server; and replying to a remote inquiry regarding proximity state of the mobile device.

9. The method as in claim 1, wherein the network device is a home wireless router.

10. The method as in claim 1, wherein the mobile device is selected from a group consisting of: a smartphone; a mobile phone; a tablet computer; a laptop computer; and a music player.

11. An apparatus, comprising:
one or more network interfaces to communicate within a communication network;
a processor coupled to the network interfaces and adapted to execute one or more processes; and
a memory configured to store a process executable by the processor, the process when executed operable to:
detect a proximity state change of a mobile device in relation to the apparatus;
compare the state change and mobile device to a set of configured policies; and
perform one or more configured actions based on one or more particular policies matching the state change and the mobile device.

12. The apparatus as in claim 11, wherein the process when executed to detect the proximity state change is further operable to:
determine whether the mobile device has connected to the apparatus or disconnected from the apparatus.

13. The apparatus as in claim 11, wherein the proximity state change is based on one of either mesh network connectivity to the network device or inter-device connectivity to the network device.

14. The apparatus as in claim 11, wherein the proximity state change is based on virtual connectivity to the network device.

15. The apparatus as in claim 11, wherein the one or more configured actions are local to the apparatus.

16. The apparatus as in claim 15, wherein the local configured actions are selected from a group consisting of: instructing an actuator to lock/unlock a door; instructing an alarm system to arm/disarm; instructing lights to turn on/off; instructing environmental controls to turn on/off; sending a notification to a locally connected user device; and logging the state change at the apparatus.

17. The apparatus as in claim 11, wherein the one or more configured actions are remote to the apparatus.

18. The apparatus as in claim 17, wherein the remote configured actions are selected from a group consisting of: sending a notification to a remotely connected user device;
sending a notification to a remote server; logging the state change at a remote server; and
replying to a remote inquiry regarding proximity state of the mobile device.

19. A system, comprising:
a mobile device; and
a network device configured to detect a proximity state change of the mobile device in relation to the network device; compare the state change and mobile device to a set of configured policies; and perform one or more configured actions based on one or more particular policies matching the state change and the mobile device.

20. The system as in claim 19, wherein the network device is configured to detect the proximity state based on one or more of: direct connectivity to the network device, mesh network connectivity to the network device, inter-device connectivity to the network device, and virtual connectivity to the network device.
